(19) United States
(12) Patent Application Publication
(10) Pub. No.: US 2020/0134476 A1
(43) Pub. Date: Apr. 30, 2020

(54) GENERATING CODE PERFORMANCE HINTS USING SOURCE CODE COVERAGE ANALYTICS, INSPECTION, AND UNSTRUCTURED PROGRAMMING DOCUMENTS

(71) Applicant: International Business Machines Corporation, Armonk, NY (US)

(72) Inventors: BRUNO SILVA, São Paulo-SP (BR); RENATO LUIZ DE FREITAS CUNHA, São Paulo (BR); Vagner Figueredo de Santana, São Paulo (BR); Lucas Correia Villa Real, Sao Paulo (BR); MARCO AURELIO STELMAR NETTO, Sao Paulo (BR)

(21) Appl. No.: 16/170,022

(22) Filed: Oct. 24, 2018

(51) Int. Cl. G06N 5/00; G06F 8/33; G06F 8/73; G06F 17/30

(52) U.S. Cl. CPC G06N 5/006; G06F 8/33; G06F 17/30722; G06F 17/30657; G06F 8/73

(57) ABSTRACT

An illustrative embodiment includes a method for improving performance of a computer. The method includes: automatically identifying an algorithm supplied by a user for execution on the computer; searching a database of algorithms for at least one algorithm similar to the user-supplied algorithm; determining whether the at least one similar algorithm will improve performance of the computer relative to the user-supplied algorithm; and if the at least one similar algorithm will improve performance of the computer relative to the user-supplied algorithm, modifying the user-supplied algorithm to incorporate at least in part the at least one similar algorithm.

### BACKGROUND

The present invention relates to the electrical, electronic and computer arts, and, more particularly, to improvements in efficient development and improvement of computer programs.

It is often said that computer programming is an art. It takes time to learn how to code efficiently, it demands attention and patience to write bug-free software, it requires knowledge about the hardware architecture in order to get good performance out of certain algorithms. Nowadays, there are several resources to assist programmers on their daily duties: integrated development environments (IDEs) spot trivial mistakes in the source code and provide auto-completion for functions and class members; social networks specialized in computer programming let users ask/answer questions and share pieces of code; compilers give hints to the user regarding best practices and potential sources of bug, to cite a few examples. Still, programmers often find themselves stuck while writing pieces of software due to e.g., the presence of non-trivial bugs, lack of domain knowledge, or unexpectedly poor performance of the program at runtime.

### SUMMARY

An illustrative embodiment includes a method for improving performance of a computer. The method includes: automatically identifying an algorithm supplied by a user for execution on the computer; searching a database of algorithms for at least one algorithm similar to the user-supplied algorithm; determining whether the at least one similar algorithm will improve performance of the computer relative to the user-supplied algorithm; and if the at least one similar algorithm will improve performance of the computer relative to the user-supplied algorithm, modifying the user-supplied algorithm to incorporate at least in part the at least one similar algorithm.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flowchart showing an exemplary process in accordance with an illustrative embodiment of the present invention;

FIG. 2 is a block diagram showing an exemplary system in accordance with an illustrative embodiment of the present invention;

FIG. 3 is a flowchart showing an exemplary process in accordance with an illustrative embodiment of the present invention;

FIG. 4 is a flowchart showing an exemplary process in accordance with an illustrative embodiment of the present invention;

FIG. 5 is a flowchart showing an exemplary process in accordance with an illustrative embodiment of the present invention;

FIG. 6 shows a computer system that may be useful in implementing one or more aspects and/or elements of the invention.

### DETAILED DESCRIPTION

An illustrative embodiment identifies code hotspots (by analyzing user interaction or testing performance) and provides hints to the code developer by using similar software. These hints may include faster implementation of user code (if a similar code is found) and/or presentation of the similar code with related explanatory material. Thus, an illustrative embodiment advantageously provides faster alternative implementation and programming hints to developers based on existing algorithms from identified code hotspots.

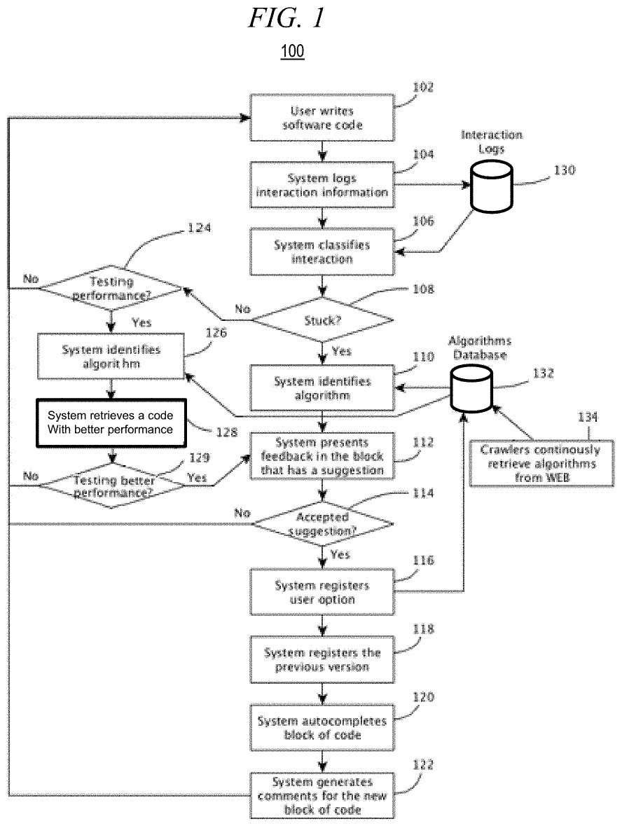

FIG. 1 is a flowchart showing an exemplary process 100 in accordance with an illustrative embodiment of the present invention. In step 102, a user writes software code, preferably using an IDE (integrated development editor). The user of the system may be a programmer, developer, or the like. Step 102 is the main loop and encompasses the period during which the user is programming. Step 134 also executes continuously in the background, in which crawlers update the algorithms database 132 with algorithms and related data retrieved, for example, from the web, as further discussed below. The algorithm database 132 registers the following elements: (i) algorithm, the actual code; (ii) algorithm metadata, tags extracted from algorithm page that can be used to cluster a set of similar algorithms; (iii) algorithm explanation, supplementary material retrieved with the algorithm code.

In step 104, the system, which may be embedded in the IDE, registers interaction events while the user is programming (e.g., interactions that the user has with the text editor of the IDE). Interaction events may include mouse events (e.g., click, movements, scrolling), keyboard events (e.g., keys down, keys up), and any additional device the user uses to interact with code development. The logs may include timestamps, how many times, a given function has been modified, how many times the code has been compiled and run in the recent past, and so on. This information is stored in the interaction logs database 130.

In step 106, the system classifies if the current interaction pattern is an outlier or not. The outlier can be defined via multiple metrics computed via interaction events logged. Metrics that can be computed with event information include mouse movements over a certain piece of code, right click over a certain compiler warning/error, key strokes per minute, number of deletions in a certain block of code, among others.

In step 108, the system computes if the user is stuck at a certain piece of code considering how he/she usually codes. For example, this determination may be based on how many times a function has been recently changed. Other examples of metrics to be used include errors/warning in the code, typing speed, scrolling speed, etc.

If step 108 determines that the user is stuck, then process 100 continues to step 110, in which the system analyzes the source code to identify the algorithm that the user is trying to implement. In step 110, the system can use algorithms database 132 (e.g., a database of known algorithms) and a multitude of techniques to find the most similar algorithm (e.g., the least distance) to the one the user is coding. Examples include techniques based on edit distance, among others. Once that algorithm has been determined in step 110, then process 100 proceeds to step 112, in which the system presents feedback to the user with a suggestion of source code changes to be made or with a documentation, extracted from the literature, of the algorithm the user is trying to implement. For example, the system may present feedback that there is a suggestion for the user in the block by displaying an icon close to the line number of the program the user is coding.

If step 108 determines that the user is not stuck, then process 100 continues to step 124, in which the system checks whether the user seems to be making changes related to performance improvements (e.g., through the detection of the use of timers). Other signs that the user may be making changes related to performance improvements may include when the user is performing slight changes in the code and/or inserting timestamped outputs to a certain block of code. If no performance-related changes are detected, then the system does back to its initial state of step 102.

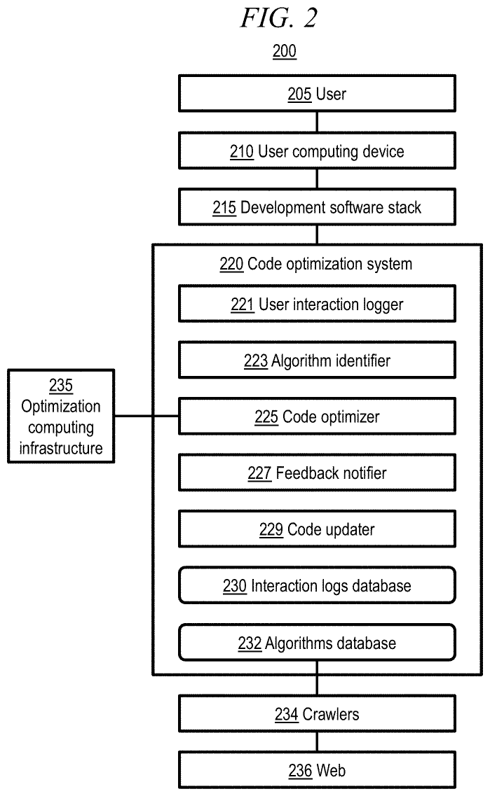

If step 124 determines that the user is testing performance, then process 100 continues to step 126, in which the system identifies the current algorithm in a manner similar to that discussed above with reference to step 110, e.g., using algorithms database 132 (e.g., a database of known algorithms) and a multitude of techniques to find the most similar algorithm (e.g., the least distance) to the one the user is coding. Once the algorithm has been identified in step 126, then process 100 continues to step 128, in which the system extracts from algorithms database 132 a code comprising one or more alternative implementations for the algorithm that may lead to improved performance. These may include, for example, implementations that explore the use of parallel processors, acceleration extensions, hand-tuned loops, etc. Step 128 may involve the optimization computing infrastructure discussed below with reference to FIG. 2.

The original code and the code with the alternative algorithms are recompiled on-the-fly and executed on a dedicated environment such as the cloud. If no significant performance improvements are observed in step 129, the system goes back to its initial state 102. Otherwise, step 129 continues to step 112, and the system presents a feedback to the user that suggests replacing the original algorithm with the optimized version.

Note that step 112 can be reached either from step 110 (within the yes branch of step 108) or step 129 (within the no branch of step 108 but the yes branch of step 124). In any case, after the system presents a suggestion to the user in step 112, step 114 determines whether the user accepts the system's suggestion. If the suggestion is not accepted in step 114, then the system goes back to its initial state 102.

If the suggestion is accepted in step 114, the process continues to step 116, in which the system records the user option within algorithms database 132 so as to avoid future recommendations for the same algorithm or to recommend again when the user finds him/herself again in the same interaction pattern while coding. In step 118, the system keeps a history of the user code (for versioning and rollback purposes) by registering a copy of the current version of the code before replacing the user code with the suggested code. In step 120, the system makes the approved changes to the source code by replacing and/or autocompleting the code. In step 122, the system generates comments for the new block of code. Given that the system already identified the algorithm and the user accepted the suggestion, the inserted code can receive the proper comment documenting the algorithm and the suggestion. Finally, the system goes back to its initial state 102.

FIG. 2 is a block diagram showing an exemplary system 200 in accordance with an illustrative embodiment of the present invention. User 205 is a user (e.g., programmer or developer) who is developing a software program code. User computing device 210 may be a laptop, desktop, or server where the user develops the code. Development software stack 215 may be the underlying environment within which the user is developing the code, such as an IDE and/or a collection of libraries. Code optimization system 220 includes various components which may be useful in performing an exemplary process, such as 100 in FIG. 1, in an illustrative embodiment of the present invention.

User interaction logger 221 is a component to log user interaction (e.g., how a user scans/navigates a code), and may be used in connection with step 104 in FIG. 1, as well as with interaction log database 230, which generally corresponds to element 130 in FIG. 1. Algorithm identifier 223 is a component to identify the algorithm in user code, and may be used in connection with steps 110 and/or 126 in FIG. 1, as well as with algorithms database 232, which generally corresponds to element 132 in FIG. 1.

Code optimizer 225 is a component to optimize user code considering the identified algorithm, and may be used in connection with step 128 in FIG. 1. Optimization computing infrastructure 235 is a computing infrastructure to perform code optimizations, which can be an on-premise server, cluster of servers, and/or a cloud environment. Feedback notifier 227 is a component to provide feedback to the user on improving the code, and may be used in connection with step 112 in FIG. 1. Code updater 229 is a component that automatically updates code upon user acceptance of suggested changes, and may be used in connection with step 120 in FIG. 1.

As discussed above with reference to step 134 in FIG. 1, crawlers 234 are components which continuously update algorithms database 232 with algorithms and related data retrieved, for example, from the web 236, which may include any internet or intranet. Example data sources within the web 236 which may be used by the crawlers 234 include tutorials, blogs, manuals, and/or troubleshooting apps. Crawlers 234 register the following elements within the algorithm database 232: (i) algorithm, the actual code; (ii) algorithm metadata, tags extracted from algorithm page that can be used to cluster a set of similar algorithms; (iii) algorithm explanation, supplementary material retrieved with the algorithm code. In one or more embodiments, the supplementary material can be used to comment the code (refer to step 122).

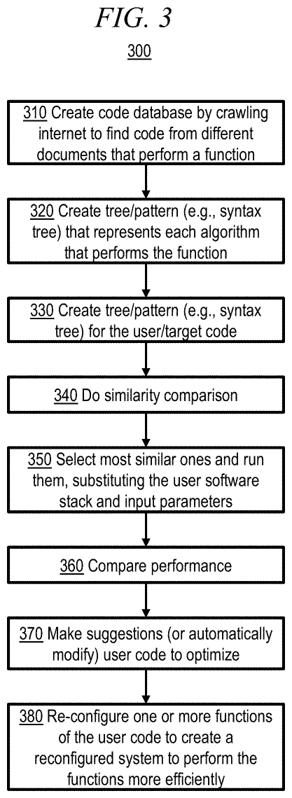

FIG. 3 is a flowchart showing an exemplary process 300 in accordance with an illustrative embodiment of the present invention. Step 310 begins by creating a code database by crawling the internet (or intranet) to find code (e.g., algorithms) from different documents that perform a given function. Step 310 generally corresponds to step 134 and/or element 234 in FIGS. 1 and 2 respectively. Step 320 creates a tree and/or pattern (e.g., a syntax tree) that represents each algorithm within the code database that performs the function. Step 330 creates a tree and/or pattern (e.g., a syntax tree) for the user/target code. Step 340 performs similarity comparisons of the algorithms within the code database to the user/target code, e.g., based on the respective syntax trees.

Step 350 selects the most similar algorithms within the code database and runs them, substituting the user software stack and input parameters. Step 350 generally corresponds to step 128 in FIG. 1. Step 360 compares the performance of the user/target code with the similar algorithms. Step 360 generally corresponds to step 129 in FIG. 1. Step 370 makes suggestions (or automatically modifies) the user code to optimize performance. Step 380 re-configures one or more functions of the user code to create a reconfigured system to perform the functions more efficiently.

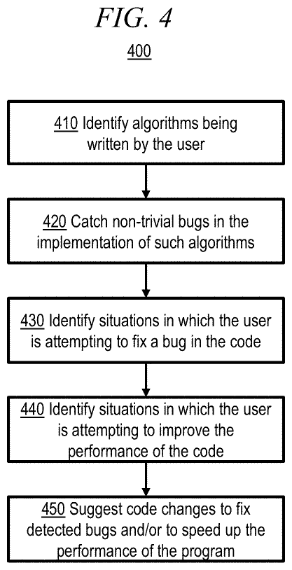

FIG. 4 is a flowchart showing an exemplary process 400 in accordance with an illustrative embodiment of the present invention. In step 410, identify algorithms being written by the user. In step 420, catch non-trivial bugs in the implementation of such algorithms. In step 430, identify situations in which the user is attempting to fix a bug in the code. Step 430 generally corresponds to step 108 in FIG. 1. In step 440, identify situations in which the user is attempting to improve the performance of the code. Step 440 generally corresponds to step 124 in FIG. 1. In step 450, suggest code changes to fix detected bugs and/or to speed up the performance of the program. Step 450 generally corresponds to step 112 in FIG. 1.

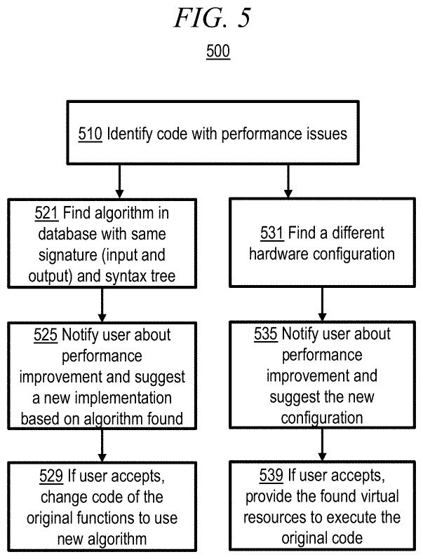

FIG. 5 is a flowchart showing an exemplary process 500 in accordance with an illustrative embodiment of the present invention. In step 510, identify code with performance issues. For example, code identified in step 510 may be:

$$boolean intersection ( Geometry g 1 , Geometry g 2 ) \{ \\ command 1 ; \\ command 2 ; \\ … \\ \}$$

In step 521, find an algorithm in the database with the same signature (input and output) and syntax tree. Step 521 generally corresponds to step 128 in FIG. 1. For example, code identified in step 520 may be:

$$boolean alternativeIntersection ( Geometry g 1 , Geometry g 2 ) \{ \\ command A 1 ; \\ command A 2 ; \\ … \\ \}$$

In step 525, notify the user about the performance improvement and suggest a new implementation based on this new algorithm. Step 525 generally corresponds to step 112 in FIG. 1. In step 529, if the user accepts the suggestion, then change the code of the original function (e.g., intersection) to implement the steps of the new algorithm (e.g., alternativeIntersection). Step 529 generally corresponds to step 120 in FIG. 1. By way of example, the changed code in step 529 may be:

$$boolean intersection ( Geometry g 1 , Geometry g 2 ) \{ \\ command A 1 ; \\ command A 2 ; \\ … \\ \}$$

Additionally or alternatively, an embodiment of the invention may not only change the software code, but may also perform re-configuration of the computer system, e.g., changing code/computer resource allocation for better performance, or even physically changing the computer architecture. Step 531 finds a different hardware configuration. Step 535 notifies the user about the performance improvement and suggests the new configuration. In step 539, if the user accepts, the found virtual resources are provided to execute the function, which may be the original function (e.g., intersection) or another function (e.g., alternativeIntersection).

One or more embodiments of the invention, or elements thereof, can be implemented, at least in part, in the form of an apparatus including a memory and at least one processor that is coupled to the memory and operative to perform exemplary method steps.

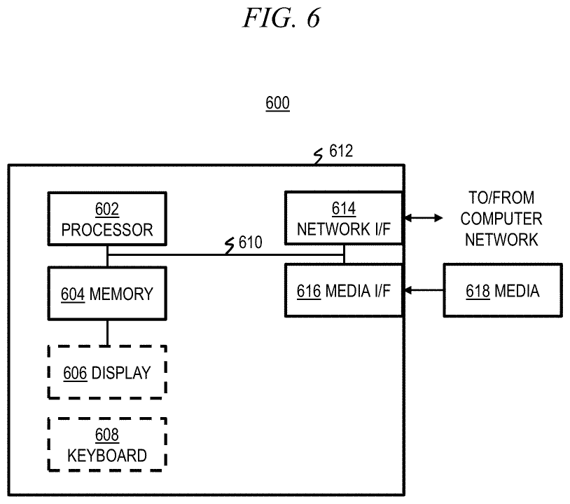

One or more embodiments can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the elements depicted in the block diagrams or other figures and/or described herein. The method steps can then be carried out using the distinct software modules and/or sub-modules of the system, as described above, executing on one or more hardware processors 602. Further, a computer program product can include a computer-readable storage medium with code adapted to be implemented to carry out one or more method steps described herein, including the provision of the system with the distinct software modules.

### Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for improving performance of a computer, the method comprising:
automatically identifying an algorithm supplied by a user for execution on the computer;
searching a database of algorithms for at least one algorithm similar to the user-supplied algorithm;
determining whether the at least one similar algorithm will improve performance of the computer relative to the user-supplied algorithm; and
if the at least one similar algorithm will improve performance of the computer relative to the user-supplied algorithm, modifying the user-supplied algorithm to incorporate at least in part the at least one similar algorithm.

2. The method of claim 1, wherein automatically identifying the algorithm comprises determining that the user is attempting to debug the algorithm based on a specific pattern of user interface interactions.

3. The method of claim 2, wherein the specific pattern of user interface interactions is determined based at least in part on at least one of a number of recent changes to the algorithm and a number of deletions in the algorithm.

4. The method of claim 2, wherein the specific pattern of user interface interactions is determined based at least in part on at least one of mouse movements over the algorithm, typing speed, and scrolling speed.

5. The method of claim 1, wherein automatically identifying the algorithm comprises determining that the user is attempting to improve performance of the algorithm based on a pattern of user interface interactions.

6. The method of claim 5, wherein the specific pattern of user interface interactions comprises inserting time-stamped outputs into the algorithm.

7. The method of claim 1, wherein searching the database for at least one algorithm similar to the user-supplied algorithm comprises computing a distance between the user-supplied algorithm and at least a subset of the algorithms of the database.

8. The method of claim 1, wherein searching the database for at least one algorithm similar to the user-supplied algorithm comprises comparing an input and output signature for the user-supplied algorithm with input and output signatures for at least a subset of the algorithms of the database.

9. The method of claim 1, wherein searching the database for at least one algorithm similar to the user-supplied algorithm comprises:
computing a syntax tree for the user-supplied algorithm;
computing syntax trees for at least a subset of the algorithms of the database; and
comparing the syntax trees for at least the subset of the algorithms of the database with the syntax tree.

10. The method of claim 1, wherein determining whether the at least one similar algorithm will improve performance of the computer relative to the user-supplied algorithm comprises:
recompiling the user-supplied algorithm and the at least one similar algorithm; and
executing the user-supplied algorithm and the at least one similar algorithm on a dedicated environment.

11. The method of claim 10, wherein the at least one similar algorithm is executed substituting the user software stack and input parameters.

12. The method of claim 1, wherein the at least one similar algorithm comprises an implementation using at least one of parallel processors, acceleration extensions, and hand-tuned loops.

13. The method of claim 1, further comprising populating the database of algorithms by using at least one crawler to extract information about algorithms from a set of unstructured data.

14. The method of claim 13, wherein the set of unstructured data is accessed via at least one of an internet and an intranet.

15. The method of claim 13, wherein the set of unstructured data comprises one or more of tutorials, blogs, manuals, and troubleshooting apps.

16. The method of claim 13, wherein the information about algorithms comprises at least one of source code and object code for each algorithm.

17. The method of claim 16, wherein the information about algorithms further comprises metadata tags that can be used to cluster a set of similar algorithms.

18. The method of claim 1, wherein modifying the user-supplied algorithm using the at least one similar algorithm comprises:
presenting a suggested modification of the user-supplied algorithm to the user; and
obtaining approval by the user for the modification prior to implementing the modification.

19. The method of claim 1, wherein modifying the user-supplied algorithm further comprises changing a hardware configuration of the computer to improve performance of the algorithm.

20. The method of claim 19, wherein changing the hardware configuration of the computer comprises providing virtual resources to execute the algorithm.

21. A non-transitory computer readable medium comprising computer executable instructions which when executed by a computer cause the computer to perform a method for improving performance of the computer, the method comprising:
automatically identifying an algorithm supplied by a user for execution on the computer;
searching a database of algorithms for at least one algorithm similar to the user-supplied algorithm;
determining whether the at least one similar algorithm will improve performance of the computer relative to the user-supplied algorithm; and
if the at least one similar algorithm will improve performance of the computer relative to the user-supplied algorithm, modifying the user-supplied algorithm to incorporate at least in part the at least one similar algorithm.

22. A computer comprising:
a memory;
at least one processor, coupled to the memory; and
a non-transitory computer readable medium comprising computer executable instructions which when loaded into the memory configure the at least one processor to improve performance of the computer by:
automatically identifying an algorithm supplied by a user for execution on the computer;
searching a database of algorithms for at least one algorithm similar to the user-supplied algorithm;
determining whether the at least one similar algorithm will improve performance of the computer relative to the user-supplied algorithm; and
if the at least one similar algorithm will improve performance of the computer relative to the user-supplied algorithm, modifying the user-supplied algorithm to incorporate at least in part the at least one similar algorithm.
